(19) United States
(12) Patent Application Publication
(10) Pub. No.: US 2026/0152998 A1
(43) Pub. Date: Jun. 4, 2026

(54) MOUNTING SYSTEM FOR FENESTRATION UNIT ACCESSORY

(71) Applicants: Andluca Technologies Inc., Rochester, NY (US); JELD-WEN, Inc., Charlotte, NC (US)

(72) Inventors: Thomas Schumann, Carson City, NV (US); Ismet Tudjinovic, Alameda, CA (US); Adrian Winoto, San Francisco, CA (US); Nicholas C. Davy, Houston, TX (US); Franklin Rolles, Charlotte, NC (US)

(21) Appl. No.: 19/458,550

(22) Filed: Jan. 23, 2026

Related U.S. Application Data
(63) Continuation of application No. PCT/US24/39463, filed on Jul. 25, 2024.
(60) Provisional application No. 63/529,099, filed on Jul. 26, 2023.

(51) Int. Cl. E06B 9/42

(52) U.S. Cl. CPC E06B 9/42

(57) ABSTRACT

The present disclosure is directed to a tool-less mounting system that allows powered window accessories, such as powered shades/blinds, for example, to be connected directly to the inside face of a fenestration frame. Mounting features of the mounting system may include a hook or hook-like extension or protrusion that extends from either the accessory or the fenestration unit. These mounting features may include a corresponding aperture or opening into the other of the accessory or fenestration unit. The hook or hook-like features may be referred-to as a “QuickHook” in some embodiments of the present disclosure. The QuickHook is meant to allow quick, tool-less connection and disconnection of the accessory/to the window frame, while allowing for power delivery and optional control signals between the accessory and a power source, such as photovoltaic glass, in the fenestration unit.

### PRIORITY

This patent application is a continuation of international patent application No. PCT/US24/39463, filed Jul. 25, 2024, entitled, “MOUNTING SYSTEM FOR FENESTRATION UNIT ACCESSORY,” and naming Thomas Schumann, Ismet Tudjinovic, Adrian Winoto, Nicholas C. Davy, and Franklin Rolles as inventors, which claims priority from provisional U.S. patent application No. 63/529,099, filed Jul. 26, 2023, entitled, “MOUNTING SYSTEM FOR FENESTRATION UNIT ACCESSORY,” and naming Thomas Schumann, Ismet Tudjinovic, Adrian Winoto, Nicholas C. Davy, and Franklin Rolles as inventors, the disclosure of which is incorporated herein, in its entirety, by reference.

### FIELD

Illustrative embodiments of the invention generally relate to mounting systems and, more particularly, relate to a mounting system for a fenestration unit accessory, such as a tool-less mounting system for a roller blind cartridge or another cartridge onto a window unit.

### BACKGROUND

Fenestration units, such as windows and doors, may include accessories that are mounted thereto. For example, windows may be covered by shades, blinds, louvers, or other window treatments to block the transmission of light through the window. The shades may be positioned on a roller that allows the shades to be rolled out to block the window and to be rolled back in to open the window to allow light to pass through the window. Alternatively, or in addition, the angle and position of blinds or louvers may be controlled by a roller that allows the blinds or louvers to be tilted closed to block the window, to be tilted open to unblock the window, and to achieve an intermediate angle and position to allow partial light transmission through the window.

Frequently, mounting such accessories on a fenestration unit requires working with tools, individual fasteners, and/or extra mounting pieces that make securing the accessory in place difficult and inconvenient. Also, the accessory may be bulky and/or aesthetically unpleasant. Conventional mounting systems for fenestration accessories may present other disadvantages as well.

### SUMMARY OF VARIOUS EMBODIMENTS

Accordingly, various embodiments of the present disclosure include a fenestration unit, an accessory, and a mounting system that operatively attaches the accessory to the fenestration unit. The fenestration may be a window, door, or other type. The accessory may be one of a variety of accessories without departing from the scope of the present disclosure. For example, the accessory may include an electrical device, such as a motor, a battery, a speaker, an alarm, circuitry, etc. The mounting system may include a quick-connecting, tool-less coupling for operatively connecting the accessory to the fenestration unit manually, without extra tools or independent fasteners. In some embodiments, the mounting system may include a projection (e.g., a hook or hook-like feature) that projects from one of the accessory and the fenestration unit, and the mounting system may include a receiver on the other of the accessory and the fenestration unit. The receiver removably receives the projection for attaching the accessory to the fenestration unit. Also, in some embodiments, the mounting system may include electrical terminals that provide electrical connection across the coupling such that electrical components of the fenestration unit (e.g., wiring, photovoltaic glass, etc.) may be electrically connected to electrical components of the accessory. The terminals of the mounting system may automatically connect as the accessory is mechanically attached to the fenestration unit, and the terminals may disconnect as a result of removal of the accessory from the fenestration unit.

In accordance with one embodiment of the invention, a window system configured to mount to a window frame having a window electrical interface includes a powered assembly having a rolling portion with first and second ends, and a shade configured to be movable in response to rotation of at least a movable portion of the rolling portion. The window system also includes a first bracket coupled with the powered assembly. The first bracket has a receiving portion to receive the first end of the rolling portion, and the first bracket includes a hook. In a corresponding manner, the window system also includes a mechanical receiving structure coupled with the powered assembly. The mechanical receiving structure has a receiving portion for receiving the hook of the first bracket.

The window system also includes a power supply in or on one or more of the first bracket, the mechanical receiving structure, and the powered assembly, and least one local electric interface configured to receive power, control signals, or both power and control signals. The power supply is electrically coupled with the motor to control the motor, while the (at least one) local electric interface is configured to make an abutting electrical connection with the window electrical interface when mounted to the window frame.

The first bracket and mechanical receiving structure are fixedly coupled with the powered assembly to form a tool-less assembly. Favorably, the first bracket and mechanical receiving structures are configured to tool-lessly connect the tool-less assembly to the window frame. The first bracket includes a hook that may be configured to hook into a mating recess on the window frame.

The rolling portion may include the movable portion and a stationary portion. At least a portion of the stationary portion may be at the first end of the rolling portion and coupled within the receiving portion of the first bracket. Moreover, among form factors, the local electric interface may be in the form of a longitudinally movable plunger normally biased outwardly from the tool-less assembly.

The window system may further include a window frame, PV glass within the frame, the window electrical interface on the window frame, and a mechanical receiving structure configured to tool-lessly connect with the first bracket and mechanical receiving structure. The window system may further include the PV glass electrically coupled with window electrical interface to provide power to the power supply when the window electric interface contacts the local electric interface. The power supply may include a battery.

The window system may further include a controller and wireless interface supported by the tool-less assembly. The controller may be configured to receive control signals via the wireless interface to control motor operation. The window system may further include an external interface to receive power from an external source other than the window. The window system may further include a motor in or on one or more of the first bracket, mechanical receiving structure, and powered assembly. The motor may control rotation of the movable portion of the rolling portion.

In accordance with another embodiment of the invention, a mounting system for coupling a structure to a window frame has a window electrical interface with a first bracket coupled to the structure. The first bracket preferably has a hook and at least one pogo pin. The mounting system also has a mechanical receiving structure coupled to a window frame. The mechanical receiving structure has an opening for receiving the hook, as well as at least one pogo pad. The mounting system also has a power supply in or on the first bracket and the mechanical receiving structure. The pogo pin and the pogo pad are electrically connected when physically contacting.

In accordance with another embodiment of the invention, a tool-less mounting system for blinds includes a blind unit with a first bracket integrated into the blind unit, and a mechanical receiving structure coupled to the first bracket. The mounting system is integrated into the blind unit and the first bracket of the blind unit is mounted tool-lessly to the mechanical receiving structure without additional parts.

In accordance with yet another embodiment of the invention, a mounting system for coupling a structure to a window frame having a window electrical interface includes a first bracket coupled to the structure. The first bracket has a hook and at least one pogo pin. The mounting system also includes a mechanical receiving structure coupled to a window frame. The mechanical receiving structure has an opening for receiving the hook, and the mechanical receiving structure has at least one pogo pad. The mounting system also has a power supply in or on one or more of the first bracket, and the mechanical receiving structure. The at least one pogo pin and the at least one pogo pad are in electrical connection.

In some embodiments, the mounting system may be a tool-less mounting system for blinds. The tool-less mounting system for blinds may include a blind unit including the first bracket integrated into the blind unit. The tool-less mounting system for blinds may also include the mechanical receiving structure being configured to tool-lessly connect with the first bracket.

The mounting system may be integrated into the blind unit, and the first bracket of the blind unit may be mounted tool-lessly to the mechanical receiving structure without additional parts.

In some embodiments, the hook may be configured to hook into the mechanical receiving structure on the window frame. The at least one pogo pin may be spring-loaded. The weight of the structure may compress the at least one pogo pin against the at least one pogo pad to form the electrical connection. The weight of the structure may firmly seat the hook into the opening in mechanical receiving structure slot to couple the structure.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below. The patent or application file contains at least one drawing executed in color. Copies of this patent or patent application publication with color drawing(s) will be provided by the Office upon request and payment of the necessary fee.

FIG. 1A shows a photograph of a roller assembly, from the left side, as it is being mounted to a window frame with a QuickHook mounting system in accordance with illustrative embodiments of a tool-less mounting system.

FIG. 1B shows a photograph of a roller assembly, from the right side, as it is being mounted to a window frame with a QuickHook mounting system in accordance with illustrative embodiments of a tool-less mounting system.

FIG. 2A schematically shows the first bracket and the mechanical receiving structure in accordance with illustrative embodiments of a tool-less mounting system.

FIG. 2B schematically shows additional drawings of the first bracket and the mechanical receiving structure in accordance with illustrative embodiments of a tool-less mounting system.

FIG. 2C schematically shows more drawings of the first bracket and the mechanical receiving structure in accordance with illustrative embodiments of a tool-less mounting system.

FIG. 3A shows a photograph of a first bracket and the mechanical receiving structure in accordance with illustrative embodiments of a tool-less mounting system.

FIG. 3B shows a photograph of a first bracket in accordance with illustrative embodiment of a tool-less mounting system.

FIG. 3C shows a photograph of a first bracket and the mechanical receiving structure in accordance with illustrative embodiments of a tool-less mounting system.

FIG. 4A shows a photograph of a first bracket and the mechanical receiving structure in accordance with illustrative embodiments of a tool-less mounting system.

FIG. 4B shows another photograph of a first bracket and the mechanical receiving structure in accordance with illustrative embodiments of a tool-less mounting system.

FIG. 5 shows a photograph of a roller shade mounted to a window frame in accordance with illustrative embodiments of a tool-less mounting system.

FIG. 6 shows a photograph of a roller shade mounted in a QuickHook first bracket in accordance with illustrative embodiments of a tool-less mounting system.

FIG. 7 shows another photograph of a roller shade mounted in a QuickHook first bracket in accordance with illustrative embodiments of a tool-less mounting system.

FIG. 8A shows a photograph of a tool-less pinch-grip snap-fit mounting system in accordance with illustrative embodiments of a tool-less mounting system.

FIG. 8B shows another photograph of a tool-less pinch-grip snap-fit mounting system in accordance with illustrative embodiments of a tool-less mounting system.

### DESCRIPTION OF ILLUSTRATIVE EMBODIMENTS

Illustrative embodiments relate to a compact, integrated, tool-less, mounting system for mounting an accessory to a fenestration unit. In some embodiments, the mounting system mechanically attaches the accessory to the fenestration unit and also electrically connects an electrical component of the accessory to an electrical component of the fenestration unit.

In some embodiments, a tool-less mounting system is disclosed that allows powered window accessories, such as powered shades/blinds, for example, to be connected directly to the inside face of a fenestration frame. Mounting features of the mounting system may include a hook or hook-like extension or protrusion that extends from either the accessory or the fenestration unit. These mounting features may include a corresponding aperture or opening into the other of the accessory or fenestration unit. The hook or hook-like features may be referred-to as a “QuickHook” in some embodiments of the present disclosure. The QuickHook is meant to allow quick, tool-less connection and disconnection of the accessory/to the window frame, while allowing for power delivery and optional control signals between the accessory and a power source, such as photovoltaic glass, in the fenestration unit.

The tool-less mounting system illustratively has several components, some of which are optional, and some of which have various versions. Generally, the mounting system has parts that mate together (e.g., corresponding male-to-female fastening features) to tool-lessly secure a powered assembly to the window frame. The figures and description below describe but a few possible options that fall within the scope of the present disclosure. Those skilled in the art can use other mating components to comply with various embodiments.

In various embodiments, some components of the mounting system include: (1) a bracket with a slot (e.g., QuickHook Receiver) with optional power connection pads that are either an integral part of the window frame, or are attached to the window frame; and (2) a corresponding mounting hook assembly (e.g., QuickHook) to engage the slot of the QuickHook Receiver with optional spring-loaded power pins (e.g., so-called “pogo pins”) to make contact with the power pads of said QuickHook Receiver. That is, a “hook” part of an insert component of the QuickHook is inserted into a slot in a bracket attached to the window frame (the QuickHook Receiver). The tool-less mounting system may rely upon the inherent weight of the accessory (e.g., roller assembly) to maintain a secure connection at the electrical terminals. In additional embodiments, the mounting system may include one or more retainer features and/or engagement features that further secure the mechanical and electrical connection. For example, the mounting system may include snap-fit features, for example, that are resiliently flexible to bias toward a connected position between the fenestration unit and the accessory. In some embodiments, the mounting system allows for connection of accessories to the window frame. The weight of the accessory compresses the optional spring-loaded pogo pins to provide a solid connection to the power pads and firmly seats the hooks into the receiver slots to mount the accessory.

The mounting system may include other features for ensuring electrical connection between the accessory and the fenestration unit. For example, the mounting system may include one or more magnetic structures or magnetic features that magnetically biases the electrical terminals toward an electrically-connected position. For example, one or both electrical terminals may include and/or may be formed of a magnetic material that magnetically-biases the terminal(s). Thus, one terminal may be magnetically attracted toward the other (i.e., from a disconnected position toward the electrically-connected position).

Although not strictly required, most accessories will have optional power pads and pogo pins. The power pads may be wired to an output of a transparent power-generating glass (such as a visibly-transparent photovoltaic glass; and/or a visibly-transparent luminescent solar concentrator device or glass) and any optional associated power management circuitry. The power pads may also be wired to a utility power source either in combination or separately.

The pogo pins may be wired to provide the power to the application circuitry associated with the accessory, such as energy storage devices, powered shade control circuitry, alarm speakers and associated circuitry, wireless communication circuitry, and any number of other applications.

The QuickHook receivers and associated accessory application hooks may be designed to have additional control signals, and are not limited to only power connections. For instance, one QuickHook could have only power connections, and another QuickHook could have both power and control signal connections. As another example, one QuickHook can have only control signals. Those skilled in the art may select the type of connection based on the desired functionality.

The QuickHook mounting system removes the need for tools to mount powered, motorized roller shade assemblies. In other words, the accessory may be mounted to the fenestration unit manually and without the need for tools or separate fasteners. Furthermore, the mounting system reduces the space required to mount powered, motorized roller shade assemblies. Additionally, the tool-less mounting system eliminates additional hardware (e.g., screws, brackets, etc.) which can be lost or damaged before assembly is completed and can add extra cost to the accessory system.

Implementation of the mounting system on window frames allows for fewer misalignment mistakes of the accessory and window, since the mounting system will be fixed in location, not requiring an end user or installer to measure and properly place brackets, screws, etc. Additional advantages include reduced parts count, and associated savings in packaging materials and savings in product shipping weight. The system allows for mounting of window accessories without the need for tools.

The QuickHook system (e.g., tool-less mounting system) greatly reduces the time necessary to install window accessories such as powered roller shades, and allows for quick interchange of accessories with varied feature levels. For example, powered shades can be exchanged with shades including light sensors or alarm speakers using the same connection scheme. The mounting system is easily adapted to accessories having “right-” or “left-handedness”. The system allows a common connection scheme for varied accessory types, including powered roller blind assemblies, electrochromic window controller, sensor housings, alarms, speaker systems, and so on.

The roller blind cartridge may contain motor drive electronics that have the capability to be controlled remotely using wireless communication methods. The wireless communication methods may include WIFI, Bluetooth, Zigbee, etc. The roller blind cartridge may contain drive electronics that provide the capability to control the blinds remotely using remote switches (momentary, bi-polar, in-glass capacitive touch, or various other types). The roller blind cartridge may be taken apart easily to service the internal elements (rechargeable or non-rechargeable battery, drive electronics, printed circuit board, motor, motor gearbox, wiring, etc.). Moreover, the roller blind cartridge or other accessory may have a fixed, non-moving inner housing for the energy storage device, an electronic printed circuit board, a motor and gear box to prevent the wiring (to and from externally connected devices, switches, sensors, etc.) from being twisted around the rotating driven roller blind tube.

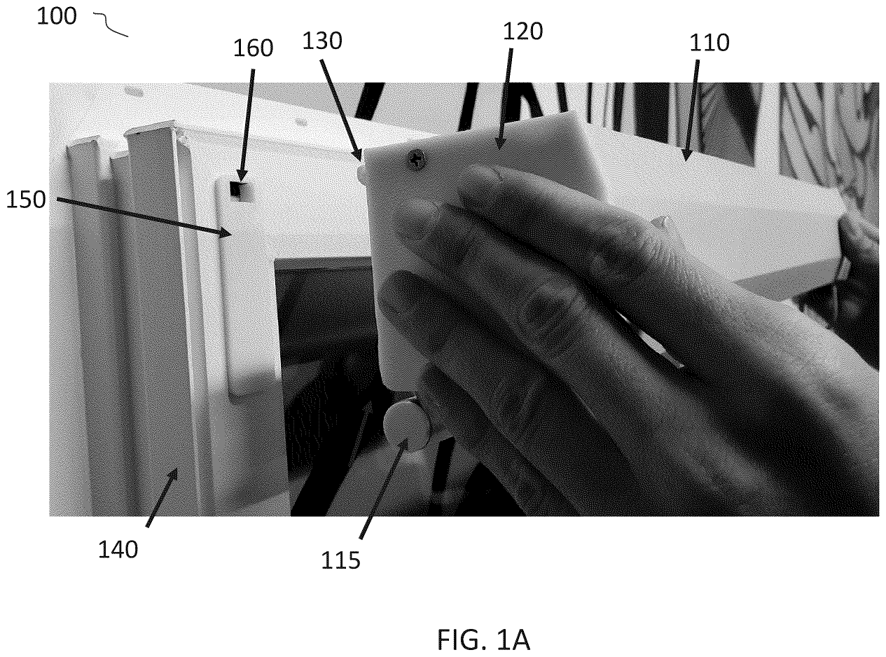

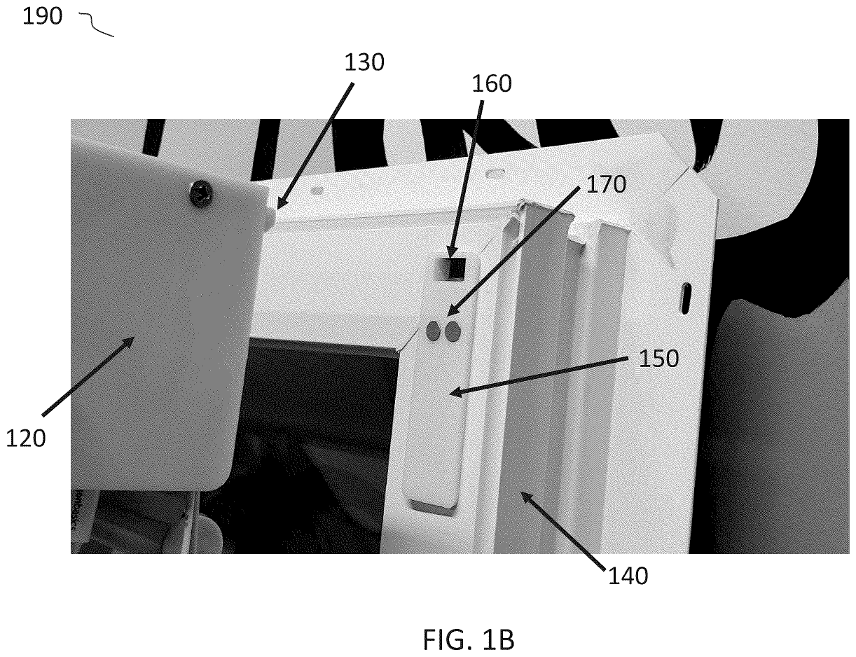

FIG. 1A shows a photograph 100 of a roller shade assembly 110, from the left side, as it is being mounted to a window frame 140 with a mounting system according to example embodiments of the present disclosure. Although a roller shade assembly 110 and window frame 140 are shown in the photograph 100, it will be appreciated that features may be incorporated in other configurations. In some embodiments, the mounting system may include features of a QuickHook mounting system and may be referred to as such. The tool-less window mounting system includes at least two brackets. A first bracket 120 (e.g., QuickHook) is integrated into the roller shade assembly 110 and has a hook 130 for coupling with a mechanical receiving structure 150. The mechanical receiving structure 150 is integrated and/or mounted to the window frame 140, and has an opening 160 (e.g., receiving portion) for receiving the hook 130 on the first bracket 120. Indeed, other embodiments may have the opposite configuration—with the opening 160 on the shade assembly 110 and the hook 130 or other coupling mechanism extending from the window.

The mounting system enables mounting the roller shade assembly 110, including a powered roller blind assembly, to a window frame 140 without tools or additional parts. The roller shade assembly 110 may be a modular, electrically-powered roller blind cartridge in which the primary power source, drive electronics and drive elements (e.g., motor and gearbox) are efficiently encapsulated into a unitized cartridge (referred to above as assembly 110).

The tool-less mounting system may be used to mount the roller shade assembly 110 (or other accessory) onto to the window frame 140. However, the mounting system may be used to mount an accessory to other structures as well without departing from the scope of the present disclosure. For example, features of the tool-less mounting system may be configured for window frames, door frames, window sashes, stand-alone roller blind housings for a window frame mounting, stand-alone roller blind housings for wall mounting, etc.

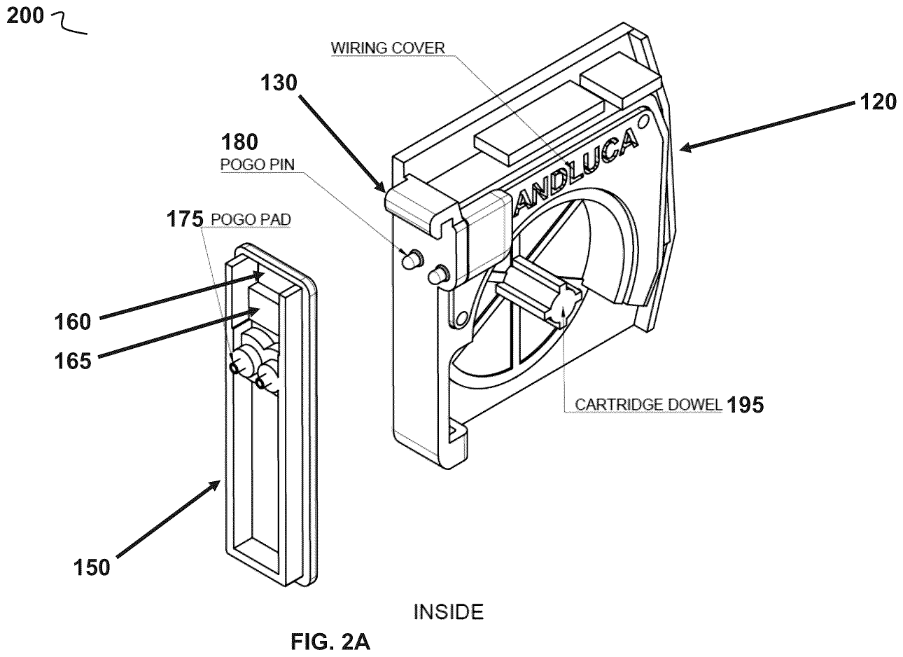

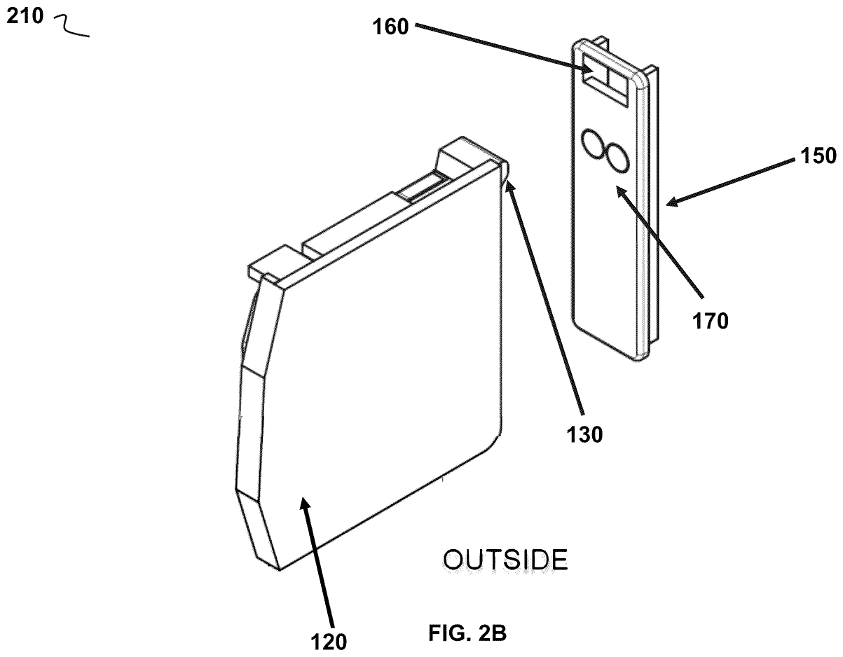

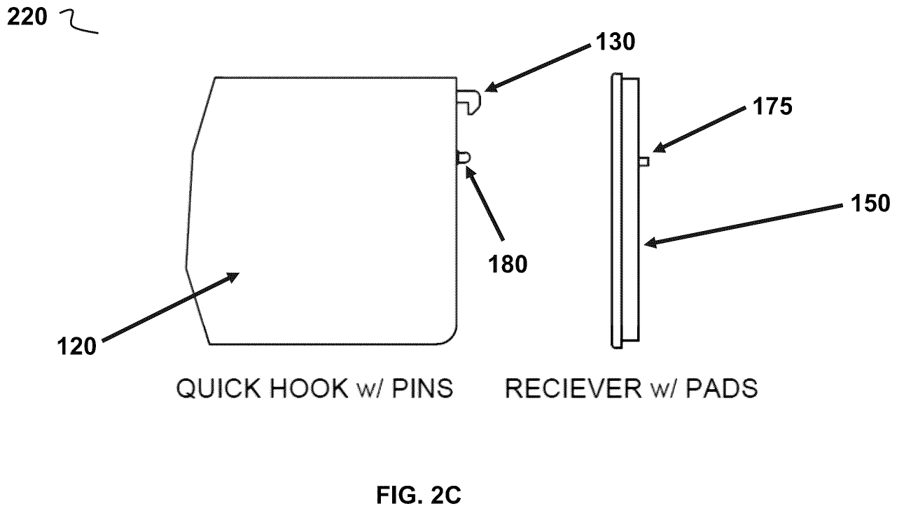

FIG. 1B shows a photograph 190 of the same roller shade assembly 110 as in FIG. 1A, from the right side, as it is being mounted to a window frame 140 with a QuickHook mounting system. During installation, the hook 130 on the first bracket 120 is received by receiving portion (e.g., opening 160) of the mechanical receiving structure 150 on the window frame 140. As shown, the mounting system may include at least one electric terminal, such as one or more power pads 170. Power pads 170 are exposed into the mechanical receiving structure 150 for an easy and convenient electrical connection. For example, pogo pins 180 (e.g., see FIG. 2C and others) mounted in the first bracket 120 make a mechanical, abutting connection with the power pads 170. This abutting connection favorably produces electrical connection to the power pads 170. The power pads 170 (e.g., pogo pins 180) are shown in a horizontal orientation, but provided enough vertical clearance between the pins, the power pads may optionally be placed in a vertical orientation or a non-orthogonal orientation relative to the X/Y/Z axes.

FIG. 2A schematically shows an inside view of the first bracket 120 (e.g., QuickHook with pins) and the mechanical receiving structure 150 (e.g., receiver with pads). The first bracket 120 includes a hook 130, biased terminals such as pogo pins 180, and a cartridge dowl 195. Upon installation, the hook 130 will be received by the opening 160 in the mechanical receiving structure 150. A raised portion 165 of the receiver (e.g., mechanical receiving structure 150) provides a raised surface against which the hook 130 makes contact. The raised portion 165 allows the hook 130 to make a snug and secure coupling with the receiver and provides leverage to the first bracket to hold the shade assembly 110 close to the mechanical receiving structure 150.

The pogo pins 180 may be spring-loaded to enable the pogo pins 180 to normally bias their leading ends toward their corresponding power pads 170. A backside view of the pogo pad connectors 175 shows electrical connections for wiring to one or more power sources.

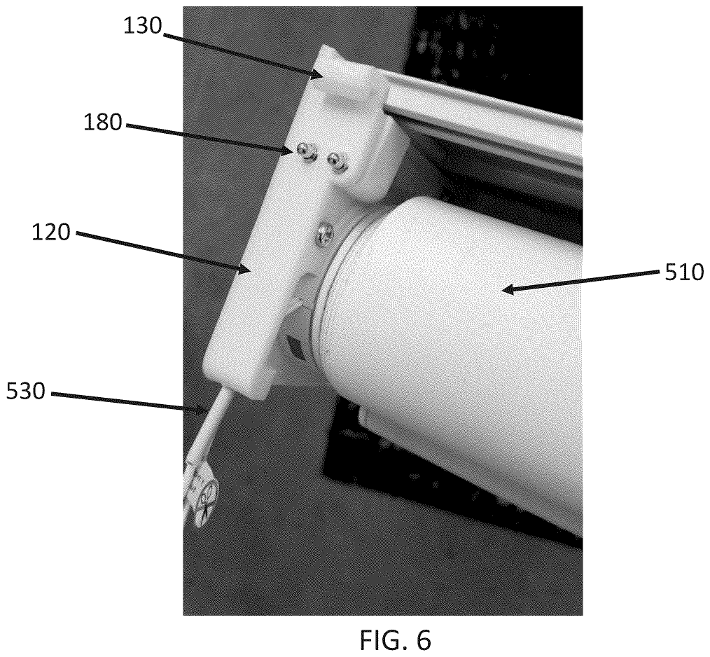

A cartridge dowl 195 is located in the first bracket 120. A roller cartridge 510 (FIG. 6) may be mounted on the cartridge dowl 195.

FIG. 2B schematically shows an outside view of the first bracket 120 (e.g., QuickHook with pins) and the mechanical receiving structure 150 (e.g., receiver with pads). This view of the first bracket 120 includes the hook 130. Upon installation, the hook 130 will be received by the opening 160 in the mechanical receiving structure 150. Power pads 170 and the opening 160 are visible on the mechanical receiving structure 150.

FIG. 2C shows drawings 220 of a side view of the first bracket 120 (e.g., QuickHook with pins) and the mechanical receiving structure 150 (e.g., Receiver with pads). This side view of the first bracket 120 includes the hook 130 and pogo pins 180. This view of the mechanical receiving structure 150 shows the pogo pads 175 directly from the side, highlighting one embodiment of a type of hook that can be used. Indeed, those skilled in the art may use any number of different types of hooks to couple within the opening 160.

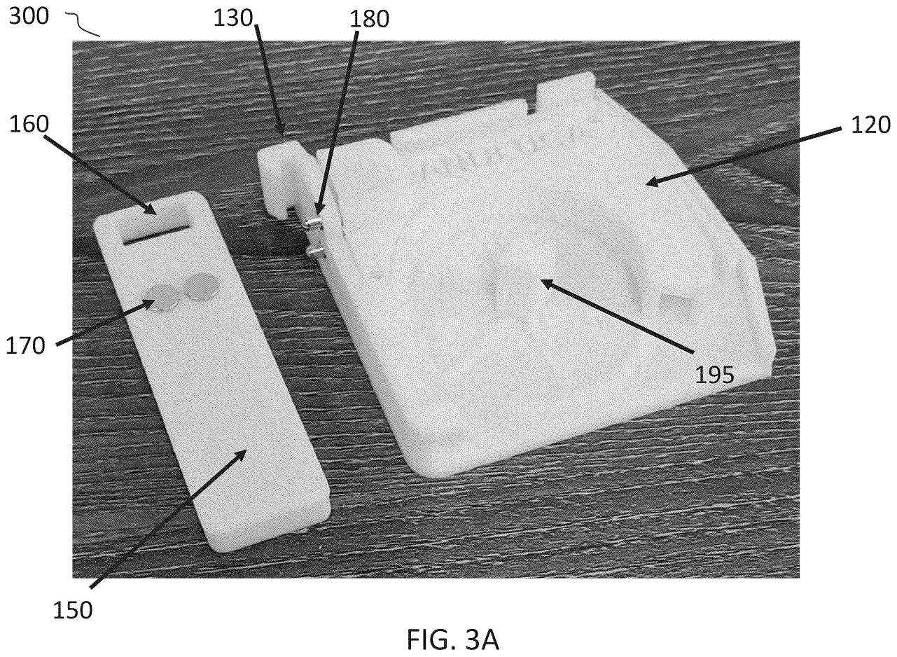

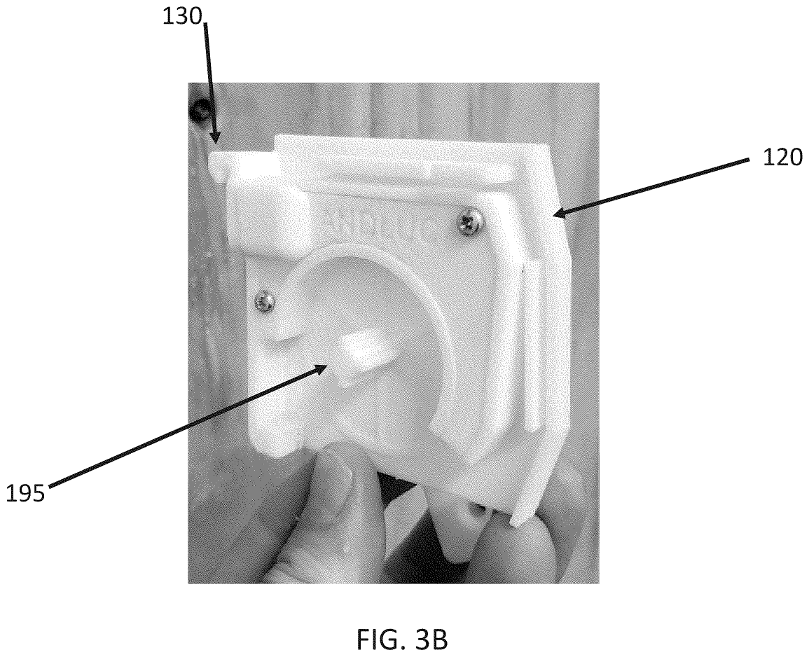

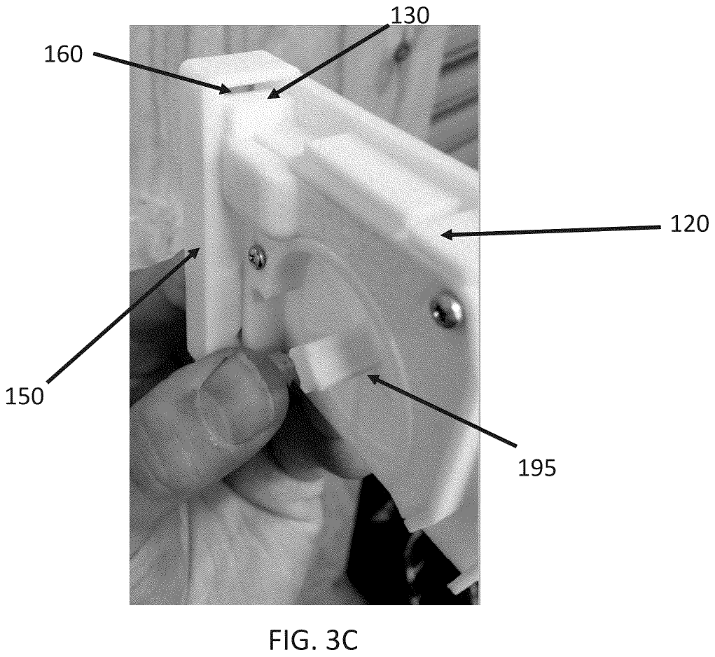

FIG. 3A shows photographs of the first bracket 120 and a mechanical receiving structure 150 in accordance with illustrative embodiments of a tool-less mounting system. The first bracket 120 in these photographs includes the hook 130, pogo pins 180, and cartridge dowl 195. The mechanical receiving structure includes the opening 160 and power pads 170.

FIG. 3B shows a photograph of the first bracket 120 in accordance with illustrative embodiments of a tool-less mounting system. The first bracket 120 in this embodiment includes the hook 130, and the cartridge dowl 195.

FIG. 3C shows a photograph of the first bracket 120 and the mechanical receiving structures 150 locked together in accordance with illustrative embodiments of a tool-less mounting system. The hook 130 is locked into the opening 160, and the cartridge dowl 195 is present.

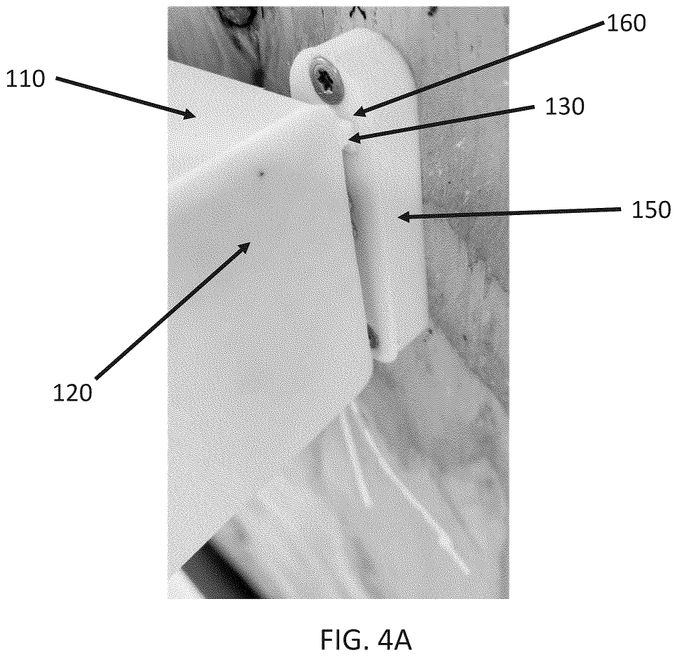

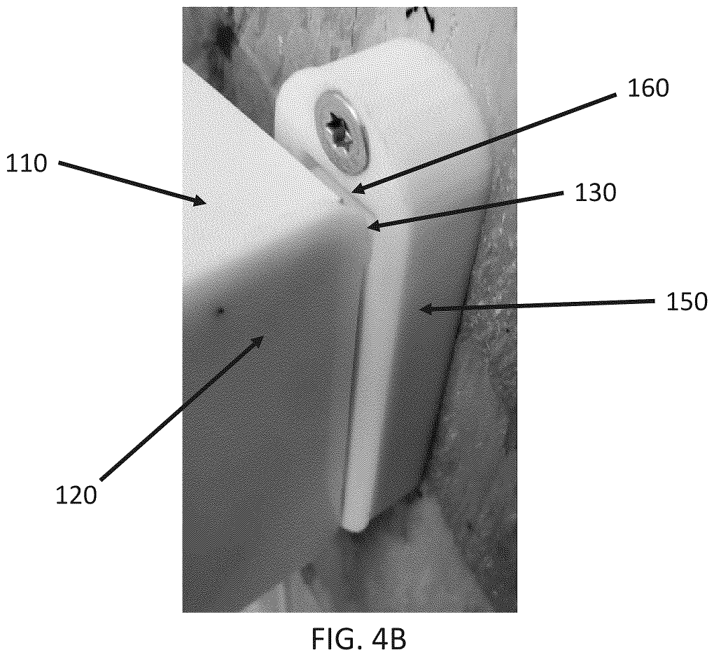

FIG. 4A shows a photograph of the first bracket 120 and the mechanical receiving structure 150 in accordance with illustrative embodiments of a tool-less mounting system. This photograph shows a roller shade assembly 110 as it is being mounted to the mechanical receiving structure 150 with the hook 130 positioned in the opening 160 prior to dropping into the locking position.

FIG. 4B shows a photograph of the first bracket 120 and the mechanical receiving structure 150 after the roller shade assembly 110 mounted to the window frame hook 130 has dropped into the locked position in the opening of the mechanical receiving structure.

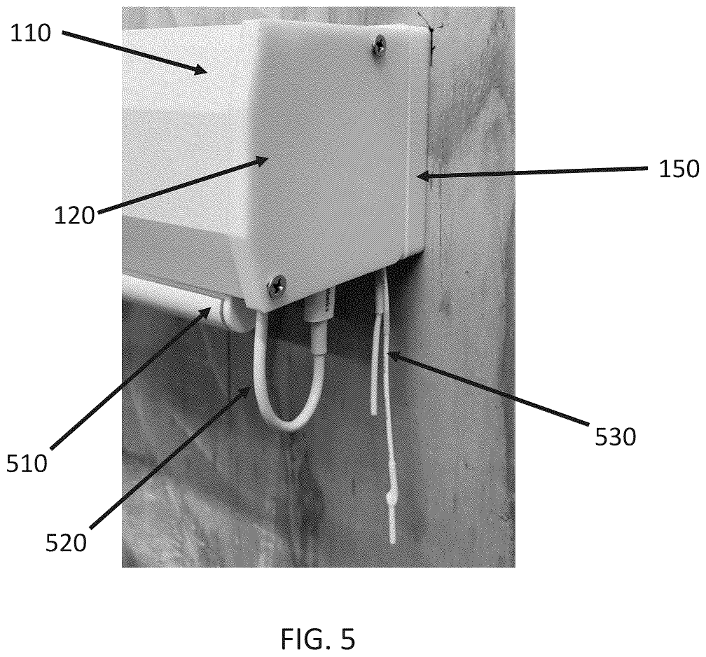

FIG. 5 shows a photograph of a roller shade assembly 110 positioned in the first bracket 120 and mounted to the mechanical receiving structure 150. The first bracket 120 is locked into the mechanical receiving structure. This figure also shows a configuration with a roller cartridge 510, a power connector 520 to receive power from an external source, and a wireless antenna 530. Among other things, the wireless antenna 530 may enable wireless (e.g., Zigbee, WiFi, or Bluetooth) or other communication between the assembly 110 and an external device (e.g., a smartphone, computer, router, or other device).

FIG. 6 shows a photograph of the roller cartridge 510 mounted in the QuickHook first bracket 120 in accordance with illustrative embodiments of a tool-less mounting system. Pogo pins 180 and the hook 130 are visible on the first bracket 120. The antenna 530 is shown coupled to the first bracket 120.

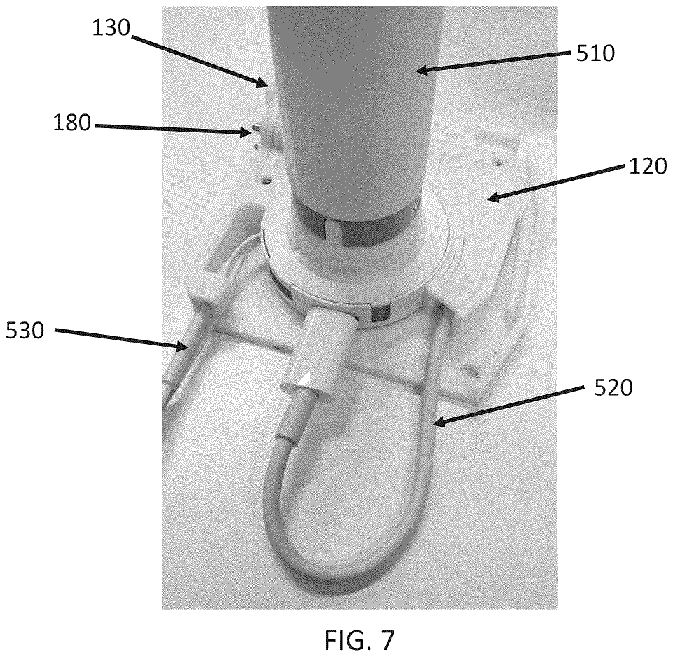

FIG. 7 shows another photograph of the roller cartridge 510 mounted in the QuickHook first bracket 120 in accordance with illustrative embodiments of a tool-less mounting system. The Pogo pins 180 and the hook 130 are visible on the first bracket 120. As shown, the first bracket 120 may be integrated with a carrier, housing, or cover of the roller cartridge 510 such that the bracket 120 and housing define a unitary, one-piece structure. The antenna 530 and power connector 520 also are shown coupled to the first bracket 120.

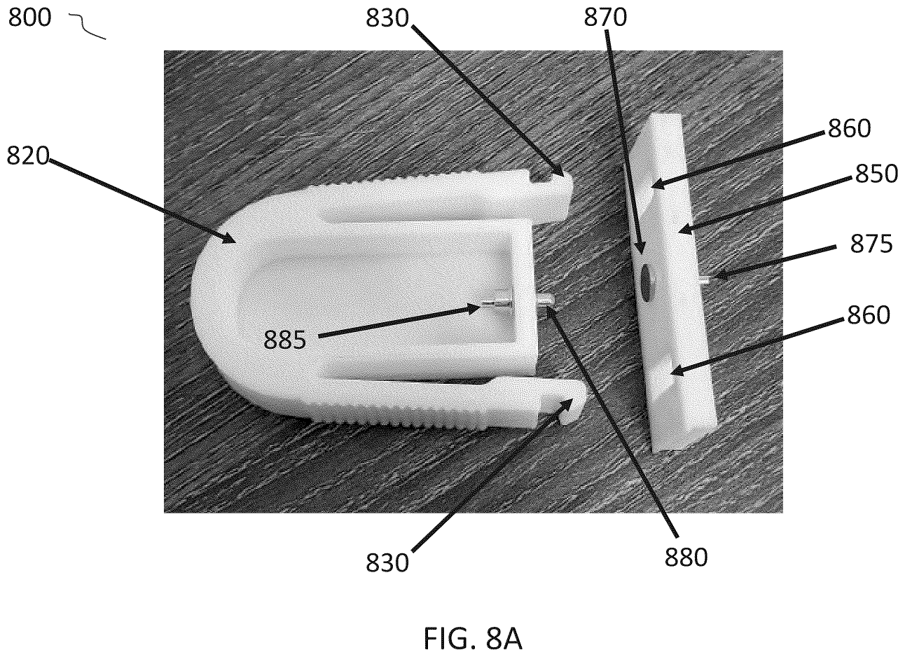

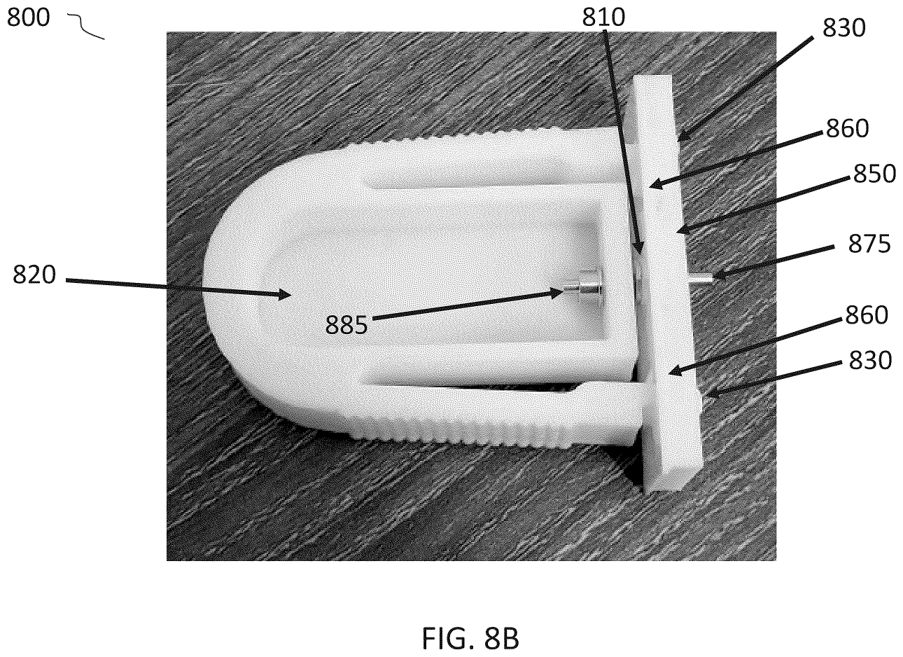

FIG. 8A shows a photograph of the first bracket 820 and the mechanical receiving structure 850 of a tool-less, snap-fit mounting system 800. In some embodiments, the snap-fit mounting system 800 may be a pinch-grip mounting system 800. The first bracket 820 has two hooks 830 as well as a pogo pin 880 with an electrical connector 885. The mechanical receiving structure 850 (e.g. receiver) has two openings 860 for receiving the two hooks 830 on the first bracket 820. The mechanical receiving structure 850 has a power pad 870 (e.g., pogo pad) with an electrical connector 875. In FIG. 8A, the first bracket 820 and mechanical receiving structure 850 are not coupled together (i.e., in a disconnected position).

FIG. 8B shows another photograph of the first bracket 820 and the mechanical receiving structure 850 of tool-less pinch-grip mounting system 800 coupled together (i.e., in a connected position) in accordance with illustrative embodiments of a tool-less pinch-grip mounting system. In FIG. 8B, the two hooks 830 of the first bracket 820 have been inserted into the two openings 860 of the mechanical receiving structure 850 to lock the first bracket 820 to the mechanical receiving structure 850.

To move the mounting system 800 from the disconnected position (FIG. 8A) to the connected position (FIG. 8B), the user may manually pinch the hooks 830 toward each other and manually move the first bracket 820 toward the receiving structure 850. The hooks 830 may include ramped surfaces that are inclined relative to the axis of insertion of the hooks 830 (horizontally in FIGS. 8A and 8B). The ramped surfaces at the ends of the hooks 830 may advance and cam against the receiving structure 850, thereby resiliently biasing the hooks 830 together as they move into the receiving structure 850. Once the hooks 830 have advanced sufficiently toward the receiving structure 850, the hooks 830 may resiliently recover to engage the receiving structure 850. In this position, the electrical connectors 875, 885 may be electrically connected. To remove the accessory, the hooks 830 may be manually pinched toward each other far enough so that the hooks 830 may be moved out of and away from the receiving structure 850 along the insertion axis (horizontally in FIGS. 8A and 8B).

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A window system configured to mount to a window frame having a window electrical interface, the window system comprising:
a powered assembly having a rolling portion having first and second ends;
a shade configured to be movable in response to rotation of at least a movable portion of the rolling portion;
a first bracket coupled with the powered assembly, the first bracket having a receiving portion to receive the first end of the rolling portion, the first bracket comprising a hook;
a mechanical receiving structure coupled with the powered assembly, the mechanical receiving structure having a receiving portion for receiving the hook of the first bracket;
a power supply in or on one or more of the first bracket, the mechanical receiving structure, and the powered assembly, the power supply electrically coupled with a motor to control the motor;
at least one local electric interface configured to receive power, control signals, or both power and control signals, the at least one local electric interface being configured to make an abutting electrical connection with the window electrical interface when mounted to the window frame;
the first bracket and the mechanical receiving structures being fixedly coupled with the powered assembly to form a tool-less assembly,
the first bracket and the mechanical receiving structures being configured to tool-lessly connect the tool-less assembly to the window frame.

2. The system of claim 1 wherein the rolling portion comprises the movable portion and a stationary portion, at least a portion of the stationary portion being at the first end of the rolling portion and coupled within the receiving portion of the first bracket.

3. The system of claim 1 wherein the at least one local electric interface comprises a longitudinally movable plunger normally biased outwardly from the tool-less assembly.

4. The system of claim 1, further comprising:
a window frame;
PV glass within the frame;
the window electrical interface on the window frame; and
a mechanical receiving structure configured to tool-lessly connect with the first bracket,
the PV glass electrically coupled with window electrical interface to provide power to the power supply when the window electric interface contacts the local electric interface.

5. The system of claim 1, further comprising:
a power storage device in electrical communication with the power system; and
the power storage device comprising a battery or capacitor either in combination or separately.

6. The system of claim 1, wherein the first bracket includes a hook configured to hook into a mating recess on the window frame.

7. The system of claim 1, further comprising:
a controller and wireless interface supported by the tool-less assembly, the controller configured to receive control signals via the wireless interface to control motor operation.

8. The system of claim 1, further comprising:
an external interface to receive power from an external source other than the window.

9. The system of claim 1, further comprising:
a motor in or on one or more of the first bracket, second bracket, and powered assembly, the motor controlling rotation of the movable portion of the rolling portion.

10. A window system configured to mount to a window frame having a window electrical interface, the window system comprising:
a powered assembly having a rolling portion having first and second ends;
a shade configured to be movable in response to rotation of at least a movable portion of the rolling portion;
a first bracket coupled with the powered assembly, the first bracket having a receiving portion to receive the first end of the rolling portion;
a second bracket coupled with the powered assembly;
a motor in or on one or more of the first bracket, second bracket, and powered assembly, the motor controlling rotation of the movable portion of the rolling portion;
a power supply in or on one or more of the first bracket, the second bracket, and the powered assembly, the power supply electrically coupled with the motor to control the motor;
at least one local electric interface configured to receive power, control signals, or both power and control signals, the at least one local electric interface being configured to make an abutting electrical connection with the window electrical interface when mounted to the window frame;
a power storage device in electrical communication with the at least one local electric interface;
the first and second brackets being fixedly coupled with the powered assembly to form a tool-less assembly,
the first and second brackets being configured to tool-lessly connect the tool-less assembly to the window frame.

11. The system of claim 10, wherein the rolling portion comprises the movable portion and a stationary portion, at least a portion of the stationary portion being at the first end of the rolling portion and coupled within the receiving portion of the first bracket.

12. The system of claim 10, wherein the at least one local electric interface comprises a longitudinally movable plunger normally biased outwardly from the tool-less assembly.

13. The system of claim 10, further comprising:
a window frame;
PV glass within the frame;
the window electrical interface on the window frame;
a mechanical receiving structure configured to tool-lessly connect with the first and second brackets, the PV glass electrically coupled with window electrical interface to provide power to the power supply when the window electric interface contacts the local electric interface.

14. The system of claim 10, wherein the power storage device comprises a battery or capacitor either in combination or separately.

15. The system of claim 10, wherein the first bracket includes a hook configured to hook into a mating recess on the window frame.

16. The system of claim 10, further comprising:
a controller and wireless interface supported by the tool-less assembly, the controller configured to receive control signals via the wireless interface to control motor operation.

17. The system of claim 10, further comprising:
an external interface to receive power from an external source other than the window.

18. A mounting system for coupling a structure to a window frame having a window electrical interface, the mounting system comprising:
a first bracket coupled to the structure, the first bracket having a hook and at least one pogo pin;
a mechanical receiving structure coupled to a window frame, the mechanical receiving structure having an opening for receiving the hook, the mechanical receiving structure having at least one pogo pad; and
a power supply in or on one or more of the first bracket, and the mechanical receiving structure, wherein the at least one pogo pin and the at least one pogo pad are in electrical connection.

19. The system of claim 18, wherein the system is a tool-less mounting system for blinds, comprising:
a blind unit comprising the first bracket integrated into the blind unit; and
the mechanical receiving structure is configured to tool-lessly connect with the first bracket, wherein the mounting system is integrated into the blind unit and the first bracket of the blind unit is mounted tool-lessly to the mechanical receiving structure without additional parts.

20. The system of claim 18, wherein:
the hook is configured to hook into the mechanical receiving structure on the window frame;
the at least one pogo pin is spring-loaded; and
the weight of the structure compresses the at least one pogo pin against the at least one pogo pad to form the electrical connection and firmly seats the hook into the opening in mechanical receiving structure slot to couple the structure.
